(19) United States
(12) Patent Application Publication
(10) Pub. No.: US 2007/0089460 A1
(43) Pub. Date: Apr. 26, 2007

(54) Method and apparatus for the conditioning and homogenization of glass melts

(75) Inventors: Matthias Lindig, Ingelheim (DE); Joachim Gesslein, Neustadt-Erlach (DE)

Correspondence Address: GREER, BURNS & CRAIN, 300 S WACKER DR, 25TH FLOOR, CHICAGO, IL, 60606, US

(73) Assignee: Beteiligungen Sorg GmbH & Co., KG.

(21) Appl. No.: 11/546,719

(22) Filed: Oct. 12, 2006

(30) Foreign Application Priority Data
Oct. 24, 2005 (DE) 102005050871.5-45

(51) Int. Cl. C03B 5/18; C03B 5/16

(52) U.S. Cl. 65/135.3; 65/178; 65/346

(57) ABSTRACT

A method and apparatus for the conditioning and homogenization of glass melts that are transported in flow channels with a vertical central longitudinal plane and side walls, by using the effect of alternating cross-section changes in the flow direction and stirrers with vertical stirrer shafts installed in the flow direction. The glass melt is transported through at least one flow channel, in which cross-section changes on both sides are created by several consecutive protrusions installed in the flow direction. The protrusions are directed towards the central longitudinal plane and on their upstream sides and downstream sides have wall areas that are arranged at such an angle to the central longitudinal plane, that no right-angled or acute-angled corners are created in the flow channel. The stirrers are installed between consecutive downstream sides and the upstream sides of the protrusions.

### BACKGROUND OF THE INVENTION

The invention concerns a method for conditioning and homogenization of glass melts that flow in flow channels with a vertical central longitudinal plane and side walls, using the effect of alternating cross-section changes and stirrers with vertical stirrer shafts, installed in the flow direction.

The Problems that Occur During the Homogenization of Glass:

A glass with certain transmission properties is produced by the addition of concentrates that influence the transmission, such concentrates being preferably added to a flint or light base glass in a forehearth or flow channel filled with glass. The concentrates, being carriers of components such as polyvalent ions that influence the transmission, are added and must first be melted. This results in differences in the concentration and the density in the glass. These must be equalized to the extent that no differences in concentration or transmission can be determined in the end product. Diffusion, assisted by convection currents in the glass bath, plays a major role in this.

However, as on the one hand very long residence times are required for these processes, and on the other hand the complete bulk of the glass is not involved in equal measure, an attempt is made to speed up these processes by means of intensive forced mixing. The aim is to mix in such a way that glass with higher and lower concentrations of components that influence the transmission are repeatedly brought together and that if possible the whole of the glass bath is included in the mixing process. These considerations also apply to processes other than coloring. During the actual mixing process the glass is pulled apart to produce the longest possible volume components with large reaction surfaces, and consequently to increase the natural diffusion processes. To this end, normally one or even several stirrers are used, which should produce optimum glass mixing.

The present invention concerns the location of the stirrers in conjunction with the design of the flow channel.

State-of-the-Art:

U.S. Pat. No. 3,328,150 and U.S. Pat. No. 3,723,084 teach the installation of several banks of spiral stirrers in a flow channel or forehearth. The number of stirrers in a bank, the number of banks, the stirrer types and rotation direction can differ and depend on the tonnage to be produced and the channel geometry.

U.S. Pat. No. 3,328,150 describes equipment for mixing molten glass, where in a flow channel, either two cuboid raised areas on the bottom and a skimmer block that projects into the melt from above, or alternatively, cuboid deflector walls that project into the melt from the sides, produce strongly meandering glass flows. Pairs of stirrers are installed between these bottom raised areas or the deflector walls perpendicular to the longitudinal axis of the flow channel. This creates right-angled stagnant areas in front of and behind the raised bottom areas or deflector walls, whereby the contents of these stagnant areas are at best barely affected by the stirring process. This results in long cleaning periods and a great loss of glass when the self-cleaning method is used after a glass change.

U.S. Pat. No. 3,723,084 teaches the mixing of glass melts in a flow channel, where two cuboid raised areas on the bottom and a skimmer block that projects into the melt from above produce a strongly vertically meandering glass flow. Stirrers are located between these bottom barriers along the longitudinal axis of the flow channel. This creates right-angled stagnant areas in front of and behind the raised bottom areas or deflector walls, whereby the contents of these stagnant areas are at best barely affected by the stirring process. This results in long cleaning periods and a great loss of glass when the self-cleaning method is used after a glass change.

The advantages of these concepts lie in their relatively simple construction. The disadvantages of these concepts lie in their limited mixing capacity. The specific load of the coloring channels is therefore limited by the fact that the base glass flows along the channel walls towards the outlet, without being influenced by the stirrers.

The known solutions should prevent unimpeded flow of the base glass. As an example, the strongly meandering current in the channel fitted with stirrers is designed to achieve this. The strongly meandering current is created by the obstacles described. It is further recommended that the glass is diverted from horizontal to vertical flow in order to increase the stirring effect. This technology is preferentially applied for the homogenization of small flow volumes in the special glass sector.

On the one hand, the diversion of the glass into a vertical flow is advantageous with regard to the homogenization effect produced. On the other hand, it also has the disadvantage that the channel bottom is not flat. When a change to a new set of coloring agents is made this means that the colored glass treated with the old coloring agents must be removed from the channel. This is achieved as a natural progression by self-cleaning by the flow through the channel. The flow through the channel is less intensive in front of and behind the obstacles, and especially in front of and behind those in the bottom that are used to divert the flow into a vertical direction. This in turn means that longer cleaning periods and high colorant and glass losses must be expected on such installations.

The problems described are also not solved satisfactorily by the state-of-the-art described below.

U.S. Pat. No. 3,352,659 discloses a method of mixing a glass melt inside a flow channel by the installation between two channel sections of a single vertical and partly cylindrical passage, in which at least two stirrer elements are installed one above the other on a vertical shaft so that the glass melt is transported along a Z-shaped path. The glass flow is concentrated by wedge-shaped projections installed in both vertical channel walls with stirrer elements located between their vertical edges. However, despite the complicated multi-level installation the mixing effect is limited and restricted to the area of the only passage.

German patent DE 1 471 832 A1 describes a method for the homogenization and coloring of glass melts by installing at least one row of stirrers across a flow channel with flat parallel walls, in order to create upward currents in the upper area of the melt. However, to enable the formation of return currents in the melt, the stirrers should not influence the bottom layer. This separation is enforced by the fact that stationary circular discs are installed below the stirrers at a distance above the flat channel bottom. This publication presents a controversial view of the problem that in the case of known stirrer systems there should be no return currents (column 2, lines 43 to 48).

U.S. Pat. No. 3,463,627 describes a method for mixing colorants into a glass melt in a flow channel with a flat channel floor and flat channel walls by the use of vertical, baffle plates independent of the side walls and at an angle to the longitudinal axis of the channel, with vertical stirrers installed between in an alternating arrangement. The baffle plates and/or the stirrers are the actual colorant transporters and therefore gradually wear away. With this method the glass melt is forced to flow in large meanders with the successive addition of colorants, whereby the final colorant is stirred the least. Furthermore the stirrer paddles are surrounded by large areas with so-called “stagnant areas”, which contain large glass quantities, which leads to long cleaning times and high glass losses at a color change. Most importantly, for a color change, the complete installation must be taken apart and the most important operating components exchanged.

German patents DE 25 52 116 A1 and DE 26 47 673 A1 describe a method for mixing in coloring agents or homogenizing the glass melt in a flow channel by the installation of two stirrers in vertical stirrer casings, these being installed as barriers across the flow channel and with vertical wall surfaces in the direction of flow. In the first stirrer casing the melt is transported from top to bottom and in the second stirrer casing the melt is transported from bottom to top. The two stirrer casings are connected to one another at the lower end. As a result of the stagnant areas, a large part of the melt volume is not affected by the stirring, so that long cleaning periods and high glass losses occur when either the color or the glass is changed.

German patent DE 31 19 816 A1 discloses a high performance forehearth for conditioning a glass current, with a flow channel in which a stirrer zone with a single vertical stirrer is installed between two cooling zones on the one hand and an equalization zone and a bowl and extraction zone on the other. This stirrer is installed in a vertical casing over a descending stepped bottom of the flow channel. The glass flows downwards in this casing, but the flow is retarded by the sense of rotation and construction of the stirrer.

In order to extend the flow path in the two cooling zones, obstacles in the form of plates are installed opposite one another on alternate sides of the strongly meandering path. Heating electrodes are installed in the stagnant areas that are created on both sides of these obstacles. Such stagnant areas also lead to long cleaning times and high glass losses during a change of glass. The equalizing zone is a pipe with an unchanging cross-section. In order to maintain glass homogeneity in the equalizing zone the design and control of the heating system is complicated. The glass content in this zone also leads to long cleaning times and high glass losses during a glass change.

German patent DE 102 53 222 A1 is concerned with the problem of glass refining by enforcing repeated changes in the glass flow direction and frequent diameter reductions by the use of special obstacles built into the channel and a reduction in the surface tension of the glass. If a stirrer unit is provided, then it should also be used to assist the mixing and homogenization of the melt. The stirrer unit consists of a stirrer in a vertical tank, into which the melt enters on one side about half way up and from which it leaves through the bottom. The gap between the stirrer and the channel wall should be less than 20 mm and the stirrer rotation speed higher than 10-20 revolutions per minute. Up to 20 baffle plates are installed as flow deflectors. The examples show flat, angled and conical baffle plates with numerous openings with relatively small cross sections. However, direct interaction between the baffle plates and the stirrer is not mentioned.

U.S. Pat. No. 5,862,169 describes a method of connecting a working end and a float bath by means of a channel with a right-angled bend for thermal conditioning and homogenization. In order to prevent stagnant areas a swan-neck is created at the bend location by reducing the channel width from two meters to one meter using two cambered wall elements installed opposite one another. On the one hand, it is disclosed that stirrers can also be installed in this channel, but on the other hand, it is not disclosed that they should be installed in the immediate vicinity of the bend and the projections. The swan-neck therefore is not used to constrict the flow in the area immediately around each stirrer.

Document No. WO 2004/070251 A1 discloses a method of vacuum degassing for expelling gas bubbles from glass melts. This process is carried out while the glass flows through metal tubes with round or oval cross-sections with sequential convex and concave longitudinal sections that successively increase and decrease the diameter of the tube and which allow variation of the pipe length as a result of vibrations. In the corresponding published U.S. Patent Application No. 2005/0268663 A1, at paragraph [0074] it is disclosed that the convex sections 20 can be pushed together or extended in an axial direction, in order to compensate for thermal expansion or shrinkage of tube 10, without changing the total length. This is not possible with ceramic materials. Where the wall thicknesses are specified they should be between 0.1 and 1.5 mm. If stirrers are mentioned they should be installed in separate chambers at a distance from such areas of variable tube diameter (FIG. 8) so that there is no interaction between them. FIG. 12 shows the analog state-of-the-art technology for this and does not have any such areas of variable diameter. This is also not an extension of a conventional forehearth or feeder with an inner ceramic lining that would resist the enforced length changes of a metallic sheath.

Japanese Patent No. JP 61-006133 A discloses the installation of five groups of stirrers in a forehearth or feeder channel split into different sectors for mixing in lead compounds for the production of table or crystal glass. The axes of each stirrer group are perpendicular to the longitudinal axis of the symmetrical feeder channel. The second to fourth stirrer groups each have five stirrers, i.e. a total of fifteen stirrers and the fifth stirrer group has five stirrers. To accommodate the second to fourth stirrer groups the feeder channel is widened and symmetrical extensions are built opposite one another, without any narrowing. The plan view of these protrusions shows a trapezoid cross-section with angled walls. In this way the tendency to create stagnant corners in the flow is suppressed. Only the inner stirrers do not interact with the angled walls. The extensions serve only to accommodate so many stirrers. These extensions result in significant volume increases, which is contrary to the object of the invention, which is to reduce both the time and amount of glass needed for a change in the glass type. It deals rather with the cladding with resistant platinum plates.

### SUMMARY OF THE INVENTION

An object of the invention is, on the one hand, to achieve effective homogenization of the main glass current in the flow channel, and on the other hand, to attain high flexibility in the complete installation. As part of this aim, a change to another type of glass should take place with the shortest possible cleaning time and the lowest possible glass losses. In particular, with coloring processes the addition of coloring agents should be reduced and, when changing from one color to the next, the shortest possible cleaning times and lowest coloring agent and glass losses should be attained.

Achievement by Means of the Inventive Process:

This object of the invention is achieved with the method described initially in that
a) the glass melt is transported along at least one flow channel, in which changes of the cross-section are produced by a series of consecutive protrusions on both sides of the channel directed towards the central longitudinal plane, whereby the upstream and downstream walls of the protrusions run inclined to the central longitudinal plane of the channel, so no right or acute angled corners are formed in the flow channel, and that
b) the stirrers are installed in the flow direction between consecutive downstream and upstream sides.

### ADVANTAGES OF THE INVENTION

On the one hand, the invention achieves effective homogenization of the main glass flow in the channel and on the other hand, achieves a high flexibility of the total plant. As a result, when the change from one glass type to the next is made, cleaning times and glass losses are reduced. In particular, with the coloring processes fewer coloring agents must be added and when the change is made to different coloring agents, shorter cleaning and shutdown times and fewer glass losses are the result.

For further embodiments of the invention it is particularly advantageous if, either singly or in combination:
the stirrers are in installed in a row along the central longitudinal plane of the channel, if the glass melt is transported between pairs of protrusions that are installed symmetrically and opposite one another and directed towards the central longitudinal plane and if the stirrers—viewed in the flow direction—are rotated between the downstream side of one pair of protrusions and the upstream side of the following pair of protrusions,
the stirrers are offset on alternate sides of the central longitudinal plane, when the glass melt is transported between a side wall and the protrusion provided on the opposite side of the channel and when the stirrers are rotated in the spaces between the side walls and the protrusions,
upward currents from the channel bottom are produced by the stirrers,
the side areas of the flow channel are heated by at least two energy sources from the group including gas burners and electrodes,
the gas burners are supplied with an oxidizing gas from the group including air, air enriched with oxygen and oxygen and/or when
the glass level near the stirrers is between 140 and 230 mm.
   Achievement by Means of the Inventive Apparatus:

The invention also concerns an apparatus for conditioning and homogenizing glass melts with at least one flow channel with a vertical central longitudinal plane and side walls, between which, viewed in the flow direction, alternating changes in the cross-section and stirrers with vertical stirrer shafts are installed in the direction of flow.

In order to achieve the same object and attain the same advantages according to the invention, it is recommended that
a) the changes to the flow channel cross-section are produced by a consecutive series of longitudinally located protrusions on both sides of the channel, that are directed towards the central longitudinal plane of the channel, whereby the upstream and downstream walls of the protrusions run inclined to the central longitudinal plane of the channel, so that no right or acute angled corners are formed in the flow channel, and that
b) the stirrers are installed in flow direction between the adjacent downstream and upstream sides of these protrusions.

For further embodiments of the invention it is particularly advantageous if, either singly or in combination:
the stirrers are in installed in a row along the central longitudinal plane of the channel, when the protrusions are installed in pairs, symmetrically and opposite one another and directed towards the longitudinal axis and if the stirrers—viewed in the flow direction—are installed between the downstream side of one pair of protrusions and the upstream side of the following pair of protrusions,
the stirrers are offset on alternate sides of the central longitudinal plane, when the protrusions are located on alternate sides of the channel and are directed towards the central longitudinal plane of the channel and when the stirrers are installed in the spaces between the side walls and the protrusions,
the stirrers are installed in the flow direction at a distance apart that is at least twice that of the crosswise offset,
at least one protrusion is installed upstream of the first stirrer viewed in the direction of flow,
at least one protrusion is installed downstream of the final stirrer viewed in the direction of flow,
the relationship between the free cross-section between opposite protrusions and the distance between the side walls is chosen in the ratio between 0.5 and 0.9,
the symmetrical protrusions in the area of the narrowest flow passage are flat and are between 0.3 and 1.0 m long when the sides walls are between 0.4 and 1.0 m apart,
the protrusions for the continuous narrowing and widening of the flow channel are trapezoid in plan view, whereby the basal planes of the protrusions are at the side walls,
the basal planes of the protrusions on opposite sides of the channel partly overlap,
the protrusions for the continuous narrowing and widening of the flow channel are in the form of waves in plan view and merge smoothly with the side walls,
the flow channel is curved and when at least one stirrer is installed before and after the curved area,
the curved area has at least one corner,
the curved area is continuously curved,
a line of stirrers is installed across the entry to the in-line configuration of stirrers and protrusions,
pockets are formed in the direction of flow between the consecutive pairs of protrusions, and these pockets are suited to the stirrer movement and stirrer contours and the stirrers protrude into such pockets, and/or, when
pockets are formed on either side of the flow channel between the consecutive protrusions, and these pockets are suited to the stirrer movement and stirrer contours and the stirrers protrude into such pockets.

The method and the apparatus are particularly suitable for the mixing of coloring agents, for the supply of molten glass to float glass tanks and for the processing of high quality glasses.

### BRIEF DESCRIPTION OF THE DRAWINGS

In the following, examples of the object of the invention and their effectiveness and other advantages are explained in detail on the basis of FIGS. 1 to 5. The figures show:

FIG. 1 is a plan view of part of a straight flow channel with four stirrers,

FIG. 2 is an enlarged vertical section through the flow channel as in FIG. 1 in the area of a stirrer,

FIG. 3 is a plan view of part of a cranked flow channel with eight stirrers,

FIG. 4 is an enlarged view taken from FIG. 1 for clarification of the geometric relationships, and

FIG. 5 is a plan view of another variation of the object of the invention analog to FIG. 4.

### DETAILED DESCRIPTION OF THE PREFERRED EMBODIMENTS

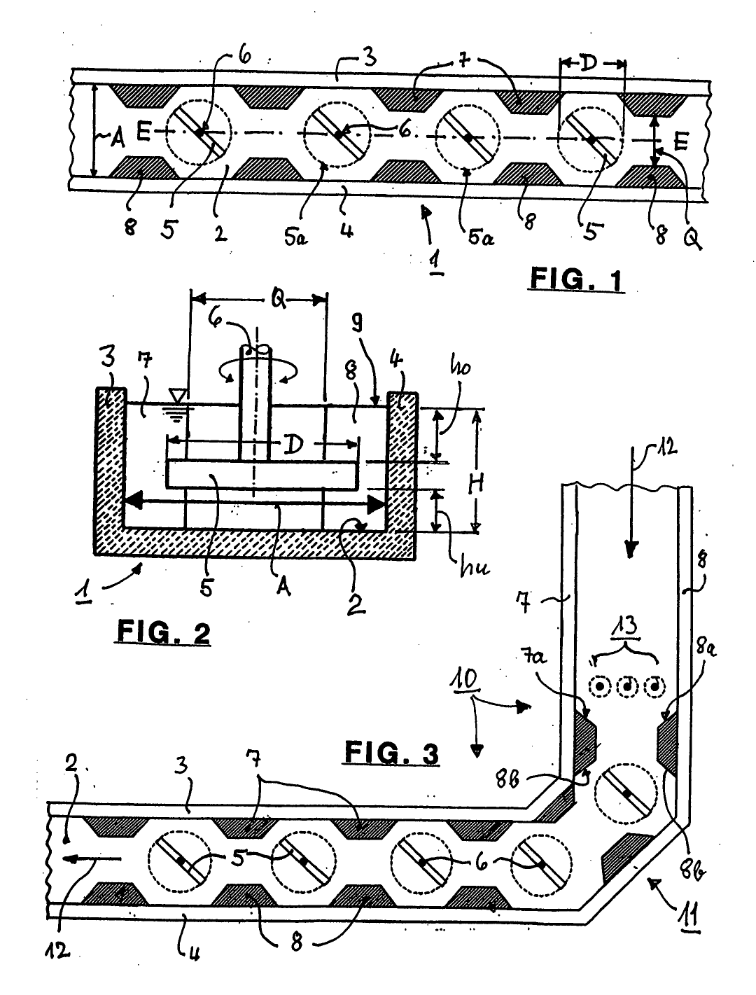

FIG. 1 shows a flow channel 1 with a flat channel bottom 2, two vertical parallel side walls 3 and 4 and four stirrers 5 with vertical stirrer shafts 6. The broken circles represent the so-called enveloping surfaces 5a that are traversed by the outermost points of the stirrer paddles during rotation of the stirrers 5. The diameter “D” of these circles and so also of the stirrer paddles, is between 360 and 560 mm. The inner channel width is defined by the clearance “A”, which is at least 400 mm and may even exceed 1000 mm, and so determines the width of the glass flow.

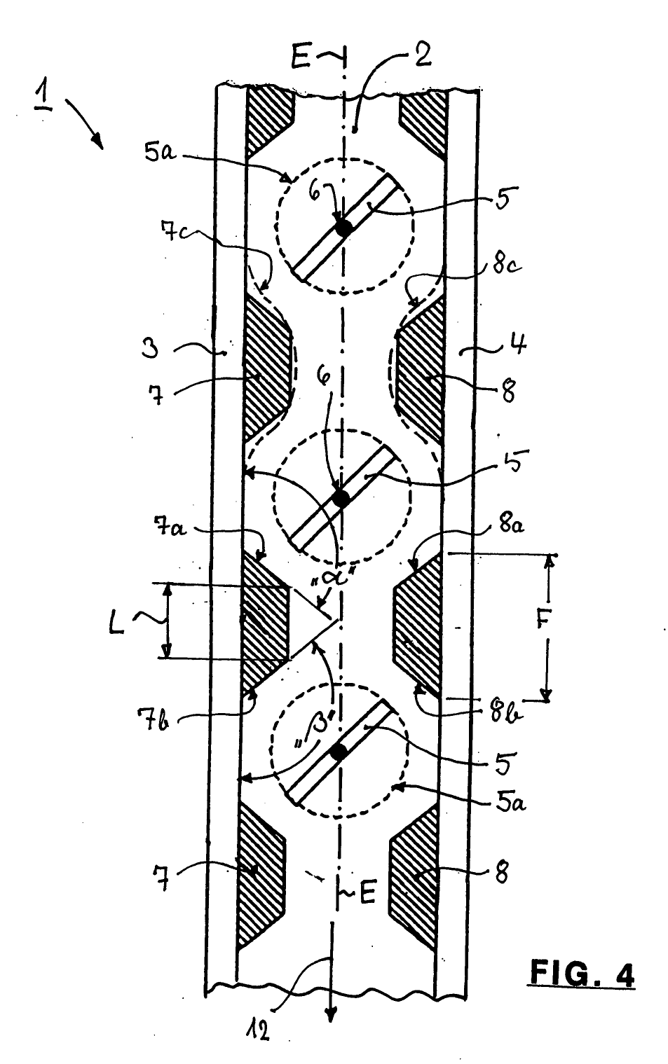

The flow channel 1 has a vertical central longitudinal plane E-E, in which the axes of the stirrer shafts 6 lie. The side walls 3 and 4 have protrusions 7 and 8, that are installed opposite to one another in pairs and symmetrical to the central longitudinal plane E-E, and reduce the clearance “A” of the cross-section to dimension “Q”. The ratio Q:A is between 0.5 and 0.9. This produces so-called pockets, in which the stirrers rotate concentrically. When viewed laterally as per FIG. 2 it can be seen that the diameter of the enveloping surfaces 5a and the protrusions 7 and 8 overlap. For further geometrical interrelationships see FIG. 4.

According to FIG. 2 there is a glass level “H” between the channel bottom 2 and the melt surface 9, which is between 140 and 230 mm. The underside of the stirrers 5 are at a clearance “hu” from the channel bottom and the upper side of the stirrers are at a clearance “ho” from the melt surface 9. Preferably “hu” is less than “ho”, so that the upward current caused by the stirrers 5 also reaches the melt at the bottom of the flow channel 1.

In the case of the stirrers 5 so-called paddle stirrers are preferred. However, the stirrers 5 may also be fitted with several layers of paddles in pairs. Furthermore the stirrers 5 can also have single paddles or stirrers with several stirrer arms that are fitted vertically above one another. The stirrer arms may have a round or flattened cross-section, and be positioned at an angle to the vertical. The arrangement, geometry, rotation speed and direction of the stirrers 5 can be further optimized. The stirrers can, for example, rotate in the same direction or alternately in opposite directions, provided that the advantageous upward currents are created.

The flow channel 1 is heated from the side by burners that are not shown. The burners are typically supplied with a pre-mix of combustion gas and air, oxygen enriched air or oxygen. The flow channel 1 can also be heated electrically by electrodes that are not shown. The electrodes protrude laterally into the melt in the flow channel 1.

The protrusions 7 and 8, that are designed to match the contours of the stirrer movement are located both upstream and downstream of the stirrers 5. It has been shown that the horizontal protrusions 7 and 8 produce flow restrictions, which are very advantageous for homogenization in comparison with a simple configuration of rows of stirrers in a flow channel with a constant width “A”.

The same numbering system is continued in FIG. 3 that demonstrates that an arrangement as shown in FIG. 1 can also be used in a curved flow channel 10. The term “curved” refers to one at least a single angled curve, a double curve—as shown—but also to a continuous curve with curvature radii, and must not necessarily be right-angled.

It is significant here that the curved area 11 can be flattened at the sides or rounded, in particular to prevent the formation of stagnant corners in the flow at this location. It can also be seen here that the principle of protrusions 7 and 8 creates pockets, in which the stirrers 5 are installed. The flow direction is shown by the arrow 12, and it can also be seen that a transverse row 13 of so-called spiral stirrers is installed in front of the row with alternating stirrers 5 and protrusions 7 and 8. Another transverse row with between 2 to 6 stirrers can also be installed immediately before the exit from the flow channel 1.

FIG. 4 shows, once again using the same numbering system, that the protrusions 7 and 8 have a trapezoidal horizontal section. In relation to the flow direction as shown by the arrow 12, these protrusions have upstream sides 7a and 8a and downstream sides 7b and 8b. Together with the side walls 3 and 4 these sides form the angles “α” and “β” that are significantly larger than right angles, for example larger than 120°. This results in pockets without stagnant corners, in which otherwise parts of the melt may become trapped, at least temporarily. The conditions can also be further improved by giving the protrusions 7 and 8 undulating contours in the flow direction, as shown in the upper part of FIG. 4 by the broken lines 7c and 8c. The basal planes “F” of these protrusions are located at the side walls 3 and 4. The length “L” of the restrictions created by the protrusions 7 and 8, measured on the side of the protrusion nearest the central longitudinal plane E-E of the flow channel 1 or 10, is preferably between 300 and 1000 mm.

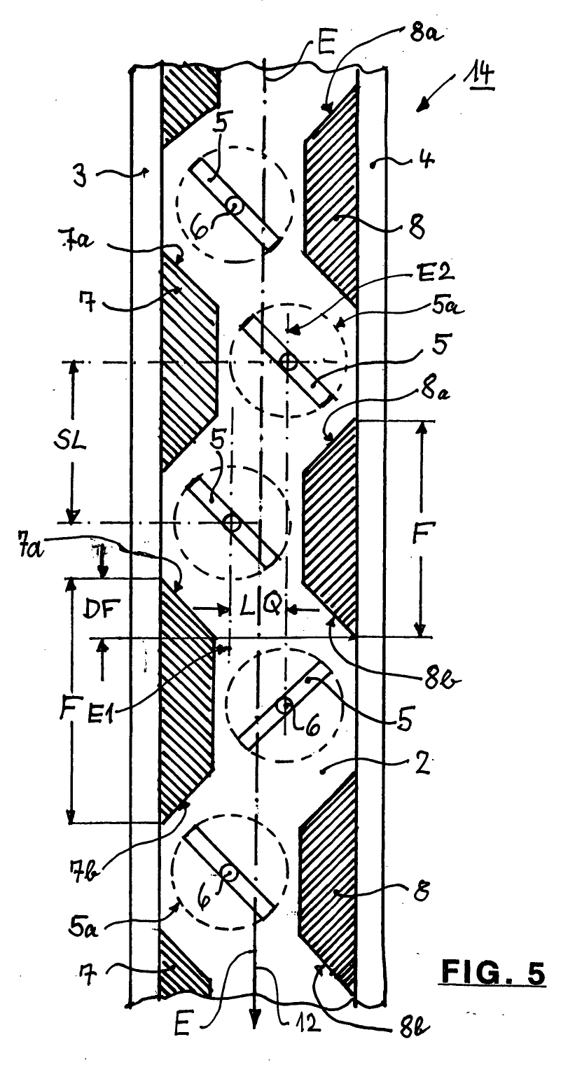

FIG. 5 shows a further example of the object of the invention in a plan view similar to FIG. 4. In the flow channel 14 the protrusions 7 and 8 are arranged offset from one another in a longitudinal direction, whereby the upstream sides 7a and 8a and the downstream sides 7b and 8b again define a trapezoidal horizontal section. As a result of the longitudinal offset of the protrusions 7 and 8 the stirrer shafts 6 are offset sideways from the central longitudinal plane E-E, so that the stirrers 5 again rotate in a sort of “pocket”, in which there are no right or acute-angled corner spaces. The longitudinal clearances “SL” between the stirrer shafts 6—viewed along the central longitudinal plane E-E—are significantly larger than the crosswise offset “LQ” of the two vertical planes E1 and E2, on which the axes of the stirrers shafts 6 are installed. This greatly reduces the extent of the meandering and the upstream sides 7a, 8a and the downstream sides 7b, 8b of the protrusions, the remaining surfaces of the trapezoidal protrusions and the inside surfaces of the side walls 3 and 4 that are exposed to the glass closely surround the enveloping surfaces 5a of the stirrers 5. It should also be mentioned that the two basal planes “F” of the protrusions 7 and 8—viewed from the side—overlap by the distance “DF”.

It should also be noted that such flow channels 1, 10 and 14 are normally installed between a melting furnace with melting, refining and conditioning areas and possibly a working end on the one hand and an extraction area for container and flat glass or rolled plate glass on the other. When coloring agents are to be added, which, for example, can be added in the form of a frit, this is done according to known principles, e.g. the addition to a flow channel near the entry from the melting installation.

However the invention is certainly not limited to coloring processes. Its use is also envisaged for special glasses that are not colored, such as, for example, for the manufacture of LCD and/or TFT glass, as this type of homogenization is also advantageous here, as here good glass homogeneity is of prime importance.

From the above description, it is apparent that the objects of the present invention have been achieved. While only certain embodiments have been set forth, alternative embodiments and various modifications will be apparent from the above description to those skilled in the art. These and other alternatives are considered equivalents and within the spirit of scope of the present invention. It should be understood that we wish to embody within the scope of the patent warranted heron all such modifications as reasonably and properly come within the scope of our contribution to the art.

We claim as our invention:

1. A method for conditioning and homogenizing glass melts flowing through flow channels with a vertical central longitudinal plane and with side walls using the effect of alternating longitudinal changes in the cross-section and stirrers with vertical stirrer shafts, installed in the flow direction, comprising the steps:
a) transporting the glass melt along at least one flow channel having two lateral sides, in which the cross-section changes are created on both sides by several consecutive protrusions installed on both sides in the direction of flow, whereby such protrusions are directed towards the central longitudinal plane and on their upstream and downstream sides have wall surfaces that run inclined to the central longitudinal plane so that no right-angled or acute-angled corners are created in the flow channel and that
b) stirring the glass melt with the stirrers which are installed in the direction of flow between the downstream sides and the upstream sides of the protrusions.

2. The method according to claim 1, wherein the step of stirring the glass melt is achieved by stirrers which are installed in a row along the central longitudinal plane, and including the steps of leading the glass melt between pairs of protrusions that are installed in a symmetrical arrangement with respect to the central longitudinal plane and rotating the stirrers, when viewed in the flow direction, between the downstream sides of a pair of protrusions and the upstream sides of the following pair of protrusions.

3. The method according to claim 1, including the steps of installing the stirrers alternately offset to each side of the central longitudinal plane, leading the glass melt between a side wall and the protrusion installed opposite and rotating the stirrers in the spaces between the side walls and the protrusions.

4. The method according to claim 1, including the step of creating upward currents with the stirrers from the channel bottom.

5. The method according to claim 1, including the step of heating the side areas of the flow channel by at least two sources of energy from a group including gas burners and electrodes.

6. The method according to claim 5 wherein gas burners are used as a source of energy, including the step of supplying the gas burners with at least one oxidation gas from a group including air, oxygen enriched air and oxygen.

7. The method according to claim 1, including the step of adjusting a level of the glass in the vicinity of the stirrers to between 140 and 230 mm.

8. An apparatus for conditioning and homogenizing glass melts with at least one flow channel with a vertical central longitudinal plane and with two side walls in which, viewed in a direction of flow, stirrers with vertical stirrer shafts and alternating longitudinal changes in the cross-section are arranged, comprising:
a) a plurality of consecutive protrusions installed on both side walls in the direction of flow to form the cross-section changes, such protrusions being directed towards the central longitudinal plane and on their upstream and downstream sides having wall surfaces that are arranged inclined to the central longitudinal plane so that no right-angled or acute-angled corners are created in the flow channel, and
b) the stirrers being installed in the flow direction between consecutive downstream sides and upstream sides of the protrusions.

9. The apparatus according to claim 8, wherein the stirrers are installed in a row along the central longitudinal plane, the protrusions are installed in a symmetrical arrangement with respect to the central longitudinal plane and the stirrers, when viewed in the flow direction, are installed between the downstream sides of a pair of protrusions and the upstream sides of the following pair of protrusions.

10. The apparatus according to claim 8, wherein the stirrers are installed alternately offset to each side of the central longitudinal plane, such that the distance perpendicular to the central longitudinal plane between stirrers is a crosswise offset and the stirrers are installed between the side walls and the protrusions.

11. The apparatus according to claim 10, wherein the stirrers are installed in the flow direction at a longitudinal clearance distance that is at least twice as large as the crosswise offset.

12. The apparatus according to claim 8, wherein at least one further protrusion is installed upstream of the first stirrer viewed in the direction of flow.

13. The apparatus according to claim 8, wherein at least one further protrusion is installed downstream of the last stirrer viewed in the direction of flow.

14. The apparatus according to claim 8, wherein the ratio between a free cross-section between opposite protrusions and a clearance between the side walls is between 0.5 and 0.9.

15. The apparatus according to claim 8, wherein the symmetrical protrusions at an area of a narrowest channel cross-section have flat sides and at a clearance of 0.4 to 1.0 m between the side walls, the protrusions have a length between 0.3 and 1.0 m.

16. The apparatus according to claim 8, wherein the protrusions for continuous constriction and expansion of the flow channel, are trapezoid in plan, whereby basal planes of the protrusions are formed at inside surfaces of the side walls.

17. The apparatus according to claim 16, wherein the stirrers are installed alternately offset to each side of the central longitudinal plane, such that the distance perpendicular to the central longitudinal plane between stirrers is a crosswise offset and the stirrers are installed between the side walls and the protrusions and wherein the basal planes of the protrusions on opposite side walls partly overlap.

18. The apparatus according to claim 8, wherein the protrusions for the continuous constriction and expansion of the flow channel appear undulating in plan view and merge smoothly into the side walls.

19. The apparatus according to claim 8, wherein the flow channel includes a curved area and at least one stirrer is installed both upstream and downstream of the curved area.

20. The apparatus according to claim 20, wherein the curved area has at least one bend.

21. The apparatus according to claim 20, wherein the curved area is continuously curved.

22. The apparatus according to claim 8, wherein a transverse row of stirrers is installed upstream of the stirrers and the protrusions.

23. The apparatus according to claim 9, wherein pockets are formed in the direction of flow between the consecutive pairs of protrusions, and these pockets are suited to the stirrer movement and stirrer contours and the stirrers protrude into such pockets.

24. The apparatus according to claim 10, wherein pockets are formed on either side of the flow channel between the consecutive protrusions, and these pockets are suited to the stirrer movement and stirrer contours and the stirrers protrude into such pockets.
